(19) United States
(12) Patent Application Publication
(10) Pub. No.: US 2017/0068254 A1
(43) Pub. Date: Mar. 9, 2017

(54) DISTRIBUTOR VALVE ASSEMBLY

(71) Applicant: Robert Bosch GmbH, Stuttgart (DE)

(72) Inventors: Alexander Hero, Lehrensteinfeld (DE); Daniel Schlingmeier, Stuttgart (DE); Giovanni Ferraro, Ludwigsburg (DE); Manuel Stoll, Stuttgart (DE)

(21) Appl. No.: 15/251,261

(22) Filed: Aug. 30, 2016

(30) Foreign Application Priority Data
Sep. 7, 2015 (DE) 10 2015 217 077.2

(51) Int. Cl. G05D 7/01; G05D 16/10; F16K 31/122; F01K 3/18; F16K 11/07

(52) U.S. Cl. CPC G05D 7/014; F01K 3/185; F16K 11/0716; F16K 31/1221; F16K 31/1223; F16K 31/1226; G05D 16/106

(57) ABSTRACT

Distributor valve assembly (1) comprising a proportioning valve (10) and a pressure compensator (30). A control piston (32) adjusts the flow cross sections through a first compensator throttle (36a) and through a second compensator throttle (36b) by longitudinal movement thereof.

### BACKGROUND OF THE INVENTION

The invention relates to a distributor valve assembly, in particular for a waste heat recovery system of an internal combustion engine.

Distributor valves are known in various embodiments from the prior art. Valves for waste heat recovery systems of internal combustion engines are likewise known from the prior art, for example from the published German patent application DE 10 2013 211 875 A1. The known valve is a distributor valve and divides a mass flow of a working medium among two evaporators of the waste heat recovery system.

To this end, the known valve comprises an inlet channel, a first outlet channel and a second outlet channel. The mass flow of the working medium is divided from the inlet channel among the two outlet channels.

A proportioning valve from the German utility model application DE 20 2013 103 743 U1 is furthermore known. This proportioning valve likewise comprises an inlet channel, a first outlet channel and a second outlet channel. The mass flow of the known proportioning valve can be divided proportionally between the two outlet channels in dependence on the position of a valve body, provided that the same pressure is applied to the two outlet channels. If, however, different pressures are applied to the outlet channels, the mass flows can thus no longer be determined through the two outlet channels without the use of downstream sensors.

### SUMMARY OF THE INVENTION

On the other hand, the mass flows through the two outlet channels can be determined without downstream sensors by means of the distributor valve assembly according to the invention. To this end, the distributor valve assembly comprises a proportioning valve and a pressure compensator. The pressure compensator equalizes the pressures at the two outlet channels of the proportioning valve; thus enabling the mass flow through the two outlet channels to be easily determined by means of the position of a valve body or respectively a slider.

The distributor valve assembly according to the invention comprises a proportioning valve and a pressure compensator. The proportioning valve comprises an inlet channel, a first outlet channel and a second outlet channel. A mass flow of a working medium flowing through the inlet channel can be divided between the first outlet channel and the second outlet channel by the proportioning valve. The pressure compensator has a control piston that is disposed in a housing so as to be longitudinally movable. A first control chamber and a second control chamber are furthermore formed in the housing. The control piston delimits the first control chamber as well as the second control chamber. The first control chamber is hydraulically connected to the first outlet channel and the second control chamber to the second outlet channel on the inlet side of the pressure compensator. On the outlet side of the pressure compensator, the first control chamber can hydraulically be connected to a first compensator outlet via a first compensator throttle and the second control chamber to a second compensator outlet via a second compensator throttle. The control piston adjusts the two flow cross sections through the first compensator throttle and through the second compensator throttle by means of the longitudinal movement thereof.

Pressures can be set in both control chambers by means of the two compensator throttles, said pressures being different from the pressures that prevail at both compensator outlets. The two compensator outlets are the outlets of the valve distributor assembly. If, for example, a higher pressure is applied to the second compensator outlet than to the first compensator outlet (and thus a higher pressure is applied to the second control chamber than to the first control chamber), the flow cross section through the first compensator throttle is then set smaller than the flow cross section through the second compensator throttle by means of the stroke of the control piston in the direction of the first compensator throttle. The drop in pressure at the first compensator throttle is accordingly greater than the drop in pressure at the second compensator throttle. As a result, pressure builds up in the first control chamber until the pressure in the first control chamber is equal to the pressure in the second control chamber and the control piston is thereby in equilibrium. The same pressures are then also applied to the two outlet channels of the proportioning valve in this position of the control piston because each outlet channel is connected to one of the pressure chambers. The distribution of the working medium mass flow among the two outlet channels and also ultimately among the compensator outlets by the proportioning valve is accordingly independent of the pressures applied to the first compensator outlet and to the second compensator outlet. The distribution of the working medium mass flow can thus be carried out robustly and can also be exactly determined without having to use downstream sensors (such as, for example, mass flow sensors downstream of the first compensator outlet and downstream of the second compensator outlet).

In one advantageous modification to the invention, the control piston is preloaded by a first preload spring and a second preload spring. As a result, excessively large oscillations of the control piston are prevented at pressure peaks in the inlet channel or in the compensator outlets. The position of the control piston, which is preloaded without pressure, is thus selected in such a way that said position—with regard to the flow cross sections of the two compensator throttles—corresponds to a common operating position.

In advantageous embodiments of the invention, the first control chamber is disposed between the first outlet channel and the first compensator throttle, and the second control chamber is disposed between the second outlet channel and the second compensator throttle. This is a simple configuration of the pressure compensator. The working medium thus flows from the first outlet channel of the proportioning valve into the first control chamber of the pressure compensator and from there to the first compensator throttle. The same applies to the second outlet channel, the second control chamber and the second compensator throttle.

The control piston advantageously has at least one first lateral surface at one end and at least one second lateral surface at the opposite end. The two lateral surfaces are oriented in the axial direction of the control piston. The at least one first lateral surface delimits the first control chamber, and the at least one second lateral surface delimits the second control chamber. As a result, two resulting hydraulic forces on the control piston occur in the axial direction: from the pressure of the first control chamber on the first lateral surface and from the pressure of the second control chamber on the second lateral surface. The at least one first lateral surface preferably has the same surface area as the at least one second lateral surface. When the pressure is equally high in the two control chambers, the two oppositely directed hydraulic forces on the two lateral surfaces cancel each other out, and the control piston is in equilibrium.

In advantageous modifications to the invention, the first control chamber and/or the second control chamber can be filled via a damping throttle. As a result, the movement of the control piston is damped and undesired vibrations are prevented. The function of the pressure compensator is thus configured more robustly. Furthermore, possible wear on the control piston is also thereby prevented.

In advantageous embodiments of the invention, a control pipe is disposed in the housing. A piston bore is configured in the control pipe, and the control piston is guided in a longitudinally movable manner in the piston bore. The control pipe is relatively easy to machine. All of the bores can be cost effectively produced. The control pipe can furthermore be manufactured from a different material than the housing so that the materials can be optimally adapted to the corresponding functions. In addition, comparatively complex but advantageous flow geometries can be configured by means of the assembly consisting of housing and control pipe.

In advantageous modifications to the invention, at least one control slot is preferably configured radially in the control pipe. The control piston comprises a closing element which together with the piston bore forms a sliding fit. The closing element covers the control slot in the region of the sliding fit in such a way that the first compensator throttle and the second compensator throttle are formed between the closing element and the control slot. In so doing, the closing element preferably covers the control slot approximately in the middle, so that respectively one compensator throttle is formed at each end of the control slot. In so doing, the closing element seals off the two compensator throttles from one another so that a short circuit cannot occur between the two compensator throttles. In principle, any number of control slots can thereby be formed, which are preferably evenly distributed over the periphery of the control pipe.

In advantageous modifications to the invention, the control piston furthermore has a first sliding body and a second sliding body. The first sliding body interacts with the piston bore and thereby delimits the first control chamber. The second sliding body also interacts with the piston bore and thereby delimits the second control chamber. As a result, the control chambers can be locally separated from the closing element. The control chambers are thus not directly influenced by the compensator throttles but are connected to the same only by means of intermediary flow geometries. In so doing, advantageous damping effects for the control piston can especially be implemented. Furthermore, a tribologically particularly advantageous guidance of the control piston can be achieved so that wear to the control piston can be prevented.

The closing element is advantageously disposed between the first sliding body and the second sliding body. A first pressure chamber is formed in the piston bore between the first sliding body and the closing element, and a second pressure chamber is formed between the second sliding body and the closing element. The direct connections from the two outlet channels of the proportioning valve to the two compensator throttles are formed via the two pressure chambers. The forces resulting hydraulically on the control piston are preferably equal to zero in the two pressure chambers so that only the pressures in the control chambers produce a stroke of the control piston.

In addition, a first connecting bore and a second connecting bore are formed in the control pipe. The first connecting bore connects the outlet channel of the proportioning valve to the first pressure chamber, and the second connecting bore accordingly connects the second outlet channel of the proportioning valve to the second pressure chamber. Alternatively, a plurality of first or respectively second connecting bores can be implemented. The production of the connecting bores in the control pipe, preferably in the radial direction, can be performed in a cost effective and simple manner.

The first compensator throttle advantageously branches off from the first pressure chamber and the second compensator throttle from the second pressure chamber. This is an arrangement of the two compensator throttles that saves on installation space.

In advantageous modifications to the invention, the first control chamber and the second control chamber are formed in the piston bore of the control pipe. The control chambers are preferably disposed respectively at both ends of the control piston so that the hydraulic forces resulting from the control chambers act on the entire length of the control piston. A plurality of functionalities are thus formed in the piston bore: the throttling into the compensator outlets through the two compensator throttles, the guidance of the control piston and the delimitation of the two control chambers.

In advantageous embodiments of the invention, the control pipe is braced in the housing by means of a mounting bolt. As a result, the control pipe is fixed in a simple manner within the housing. Said control pipe can thus be mounted in a correspondingly cost effective manner.

In advantageous modifications to the invention, the mounting bolt delimits the second control chamber. Furthermore, the second control chamber can be filled via a connecting channel formed in the mounting bolt. This connecting channel is preferably designed as a damping throttle. As a result, a plurality of functions can be carried out by the mounting bolt such that installation space is saved: the fixing of the control pipe, the sealing of a control chamber and the filling of a control chamber.

In an advantageous embodiment of the invention, the inventive distributor valve assembly is disposed in a waste heat recovery system of an internal combustion engine. The waste heat recovery system has a circuit for conveying a working medium, wherein the circuit comprises a pump, a distributor valve, two evaporators connected in parallel, an expansion machine and a condenser in the direction of flow of the working medium. The distributor valve controls the mass flows of the working medium to the two evaporators. The distributor valve is in this case the distributor valve assembly according to the invention. As a result, the mass flow of the working medium can, in dependence on the capacity of the two evaporators, be divided between said two evaporators in an optimally proportional and continuous manner regardless of what pressures are applied to the two evaporators. An expensive array of sensors for determining the mass flow through the two evaporators can thereby be avoided. It is, for example, sufficient to know the rate of flow of the working medium through the pump and the valve position of the proportioning valve of the valve distributor assembly.

### BRIEF DESCRIPTION OF THE DRAWINGS

FIG. 1 shows a longitudinal section of a proportioning valve, wherein only the essential regions are depicted.

FIG. 2 shows a schematic longitudinal section of an inventive distributor valve assembly comprising a proportioning valve and a pressure compensator, wherein only the essential regions are depicted.

FIG. 3 shows another exemplary embodiment of a pressure compensator in longitudinal section, wherein only the essential regions are depicted.

FIG. 4 shows yet another exemplary embodiment of a pressure compensator in longitudinal section, wherein only the essential regions are depicted.

FIG. 5 shows schematically a distributor valve assembly according to the invention within a waste heat recovery system.

### DETAILED DESCRIPTION

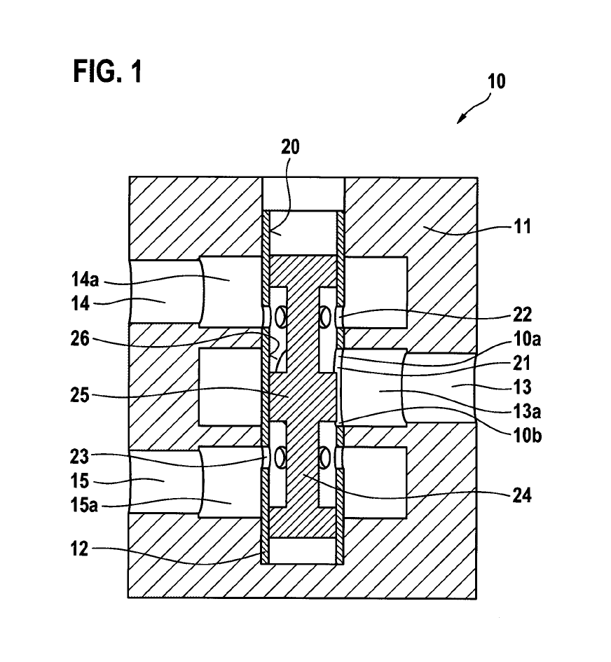

FIG. 1 shows a longitudinal section of a proportioning valve 10 designed as a slide valve, wherein only the essential regions are depicted. The proportioning valve 10 can continuously divide a mass flow of the working medium. In the exemplary embodiment of FIG. 1, the proportioning valve 10 is designed as an input controlled slide valve.

The proportioning valve 10 comprises a valve housing 11, in which a valve tube 12 is disposed, for example press-fitted. An inlet channel 13 comprising an inlet annular groove 13a, a first outlet channel 14 comprising a first outlet annular groove 14a and a second outlet channel 15 comprising a second outlet annular groove 15a are configured in the valve housing 11. The inlet annular groove 13a, the first outlet annular groove 14a and the second annular ring groove 15a are disposed so as to radially surround the valve tube 12, wherein, as seen in the axial direction, the inlet annular groove 13a is disposed between the two outlet annular grooves 14a, 15a.

A row of inlet bores 21, a first row of outlet bores 22 and a second row of outlet bores 23 are configured in the valve tube 12, wherein each row is disposed in each case annularly over the periphery of the valve tube 12. The inlet bores 21 are in each case configured in the shape of slots. The valve tube 12 is positioned in the valve housing 11 such that the inlet bores 21 are disposed radially within the inlet annular groove 13a, the first outlet bores 22 within the first outlet ring groove 14a and the second outlet bores 23 within the second outlet ring groove 15a.

In the valve tube 12, a guide bore 20 is formed in the longitudinal direction, into which guide bore the inlet bores 21, the first outlet bores 22 and the second outlet bores 23 open radially. In the exemplary embodiment of FIG. 1, the row of the inlet bores 21 is disposed between the rows of first outlet bores 22 and second outlet bores 23 as seen in the longitudinal direction.

A slide 24 is guided in the guide bore 20 so as to move longitudinally, wherein the longitudinal movement of the slide 24 is controlled by a control device, which is not depicted. The control device can, for example, be driven electromagnetically, piezo-electrically, pneumatically or hydraulically, therefore in principle with a motor of any type. The mass flow of the working medium from the inlet channel 13 is divided between the first outlet channel 14 and the second outlet channel 15 by means of the longitudinal movement of the slide 24. In the exemplary embodiment of FIG. 1, the mass flow is divided in an input controlled manner, i.e. at the inlet bore 21.

To this end, an inlet-side closing cylinder 25 is arranged on the slide 24, said closing cylinder forming a sliding fit 26 with the guide bore 20 in the region of the inlet bores 21 in order to open or close said inlet bores 21 by the closing cylinder 25 exposing or covering said inlet bores 21.

In the central position of the slide 24—i.e. in a position open to both outlet bores 22, 23 or respectively to both outlet channels 14, 15—the closing cylinder 25 of the slide 24 is disposed in the guide bore 20 in the axial direction between the inlet bores 21; said closing cylinder therefore covers the sliding fit 26 centrally. In so doing, the closing cylinder 25 can partially but not completely cover the inlet bores 21. In this position, a first hydraulic valve connection from the inlet channel 13 to the first outlet channel 14 is open and simultaneously a second hydraulic valve connection from the inlet channel 13 to the second outlet channel 15 is also open.

The slide 24 interacts in the sliding fit 26 with the inlet bores 21 such that two throttles are formed by the partial covering of the inlet bores 21 by the slide 24 or respectively by the closing cylinder 25: a first slide throttle 10a, which determines the mass flow through the first hydraulic valve connection, and a second slide throttle 10b, which determines the mass flow through the second hydraulic connection. The inlet bores 21 are thus designed as a function of the stroke of the slide 24 to the two variable slide throttles 10a, 10b.

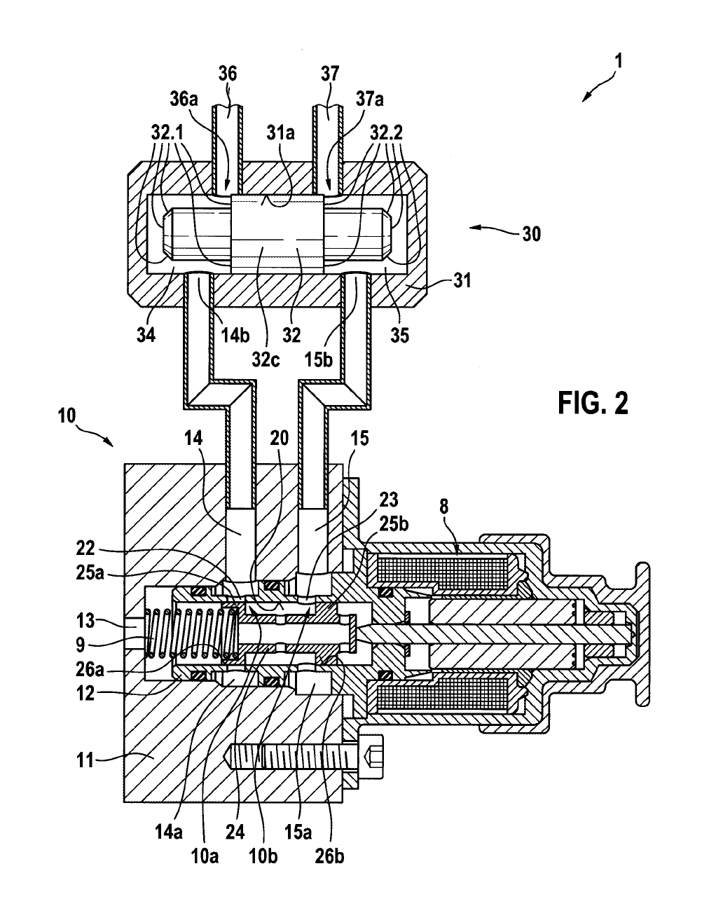

FIG. 2 shows a schematic longitudinal section of a distributor valve assembly 1 according to the invention. The distributor valve assembly 1 comprises the proportioning valve 10 designed as a slide valve and a pressure compensator 30. The proportioning valve 10 can continuously divide a mass flow of a working medium and is designed as an outlet controlled slide valve, wherein said proportioning valve can also alternatively be designed in an input controlled manner.

The proportioning valve 10 comprises the valve housing 11, in which the valve tube 12 is disposed, for example press-fitted or clamped. The inlet channel 13, the first outlet channel 14 comprising the first outlet annular groove 14a and the second outlet channel 15 comprising the second outlet annular groove are configured in the valve housing 11. The inlet channel 13 is disposed on the end face in relation to the two outlet channels 14, 15. The first outlet annular groove 14a and the second outlet annular groove 15a are disposed so as to radially surround the valve tube 12.

The at least one first outlet bore 22 and the at least one second outlet bore 23 are formed in the valve tube 12. The valve tube 12 is positioned in the valve housing 11 such that the first outlet bores 22 are disposed within the first outlet annular groove 14a and the second outlet bores 23 within the second outlet annular groove 15a.

The guide bore 20 is formed in the longitudinal direction in the valve tube 12, into which guide bore the inlet channel 13 at the end face and the first outlet bores 22 and the second outlet bores 23 open radially. The slide 24 is disposed in the guide bore 20 so as to move longitudinally, wherein the longitudinal movement of the slide 24 is controlled by an electromagnetic actuator 8 and a spring 9. The control device can, however, alternatively be designed in a piezo-electric, pneumatic or hydraulic manner; thus in principle with a motor of any type. The mass flow of the working medium is divided between the first outlet channel 14 and the second outlet channel 15 by means of the longitudinal movement of the slide 24. In the exemplary embodiment of FIG. 2, the division of the mass flow takes place in an outlet controlled manner, i.e. at the two outlet bores 22, 23.

To this end, two closing cylinders are configured on the slide 24: a first closing cylinder 25a and a second closing cylinder 25b. The first closing cylinder 25a together with the guide bore 20 forms a first sliding fit 26a in the region of the first outlet bores 22 by the first closing cylinder 25a exposing or respectively covering the first outlet bores 22. The first closing cylinder 25a interacts with the first sliding fit 26a in such a way that the variable first slide throttle 10a is formed at the first outlet bore 22, wherein the first slide throttle 10a determines the rate of flow from the inlet channel 13 to the first outlet channel 14—i.e. in the first hydraulic valve connection.

The second closing cylinder 25b together with the guide bore 20 forms a second sliding fit 26b in the region of the second outlet bores 23 by the second closing cylinder 25b exposing or respectively covering the second outlet bores 23. The second closing cylinder 25b interacts with the second sliding fit 26b in such a way that the variable second slide throttle 10a is formed at the second outlet bore 23, wherein the second slide throttle 10b determines the rate of flow from the inlet channel 13 to the second outlet channel 15—i.e. in the second hydraulic valve connection.

The pressure compensator 30 comprises a housing 31, wherein a piston bore 31a is formed in the housing 31, said piston bore comprising a first control chamber 34 and a second control chamber 35. On the inlet side, the first control chamber 34 is connected to the first outlet channel 14 via a first inlet bore 14b, and the second control chamber 35 is connected to the second outlet channel 15 via a second inlet bore 15b. On the outlet side, the first control chamber 34 is connected to a first compensator outlet 36 and the second control chamber 35 to a second compensator outlet 37.

A substantially cylindrical control piston 32 is disposed in a longitudinally displaceable manner in the piston bore 31a such that said control piston separates the first control chamber 34 from the second control chamber 35 in a media-impermeable manner. A closing element 32c arranged on the control piston 32 is therefore disposed between the first compensator outlet 36 and the second compensator outlet 37 and interacts with the piston bore 31a in such a way that said closing element can cover the first compensator outlet 36 as well as the second compensator outlet 37. In this way, the control piston 32 together with the first compensator outlet 36 forms a variable first compensator throttle 36a and together with the second compensator outlet 37 a variable second compensator throttle 37a.

As a result, two further hydraulic connections are formed in the pressure compensator 30:

a first hydraulic connection from the first inlet bore 14b, into the first control chamber 34 and from there further into the first compensator outlet 36 via the first compensator throttle 36a and

a second hydraulic connection from the second inlet bore 15b, into the second control chamber 35 and from there further into the second compensator outlet 37 via the compensator throttle 37a.

In further exemplary embodiments, the closing element 32c of the control piston 32 can completely close the first compensator outlet 36 in a first end position so that the first hydraulic connection is interrupted; and the closing element 32c can completely close the second compensator outlet 37 in a second end position so that the second hydraulic connection is interrupted.

Two oppositely directed hydraulic forces act on the control piston 32 in the axial direction, namely those which result from the pressures in the two control chambers 34, 35. The pressure of the first control chamber 34 acts on the first lateral surfaces 32.1 of the control piston 32, and the pressure of the second control chamber 35 acts on the second lateral surfaces 32.2 of the control piston 32. The surface areas of the two lateral surfaces 32. 1, 32.2 are the same size so that the resulting hydraulic force on the control piston 32 in the axial direction is equal to zero if the pressure in the first control chamber 34 and in the second control chamber 35 are the same size.

Depending on the pressure ratio between the first control chamber 34 and the second control chamber 35, the control piston 32 is displaced in the direction of the lower pressure by means of the resulting hydraulic total force. If, for example, a higher pressure prevails in the first control chamber 34 than in the second control chamber 35, the control piston 32 is displaced in the direction of the second control chamber 35—provided that the first lateral surfaces 32.1 and the second lateral surfaces 32.2 have the same surface area. As a result, the flow cross section of the second compensator throttle 37a is reduced and the flow cross section of the first compensator throttle 36a is simultaneously increased. In this way, the pressure gradients in the two hydraulic connections at the respective compensator throttle 36a, 37a can be influenced.

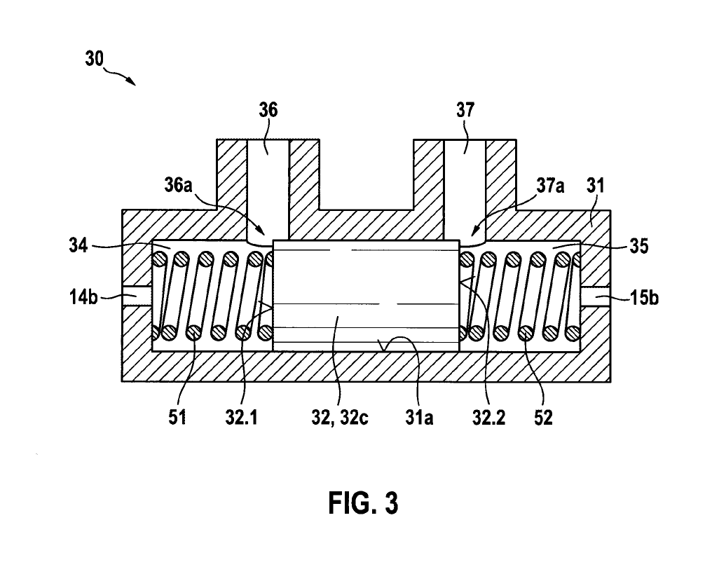

FIG. 3 shows a further exemplary embodiment of a pressure compensator 30. The pressure compensator 30 comprises the housing 31, wherein the piston bore 31a is formed in the housing 31, said piston bore comprising the first control chamber 34 and the second control chamber 35. On the inlet side, the first inlet bore 14b opens into the first control chamber 34 in the axial direction and the second inlet bore 15b opens into the second control chamber 35 in the axial direction. On the outlet side, the first control chamber 34 is connected to the first compensator outlet 36 and the second control chamber 35 to the second compensator outlet 37.

The control piston 32 or respectively the closing element 32c separates the first control chamber 34 hydraulically from the second control chamber 35. The closing element 32 furthermore forms the variable first compensator throttle 36a at the first compensator outlet 36 and the variable second compensator throttle 37a at the second compensator outlet 37.

A first preload spring 51 is disposed in the first control chamber 34 between the housing 31 and the control piston 32. A second preload spring 52 is disposed in the second control chamber 35 between the housing 31 and the control piston 32. The first preload spring 51 acts on the first lateral surface 32.1 and the second preload spring 52 acts on the second lateral surface 32.2. Both springs are designed as compression springs and preload the control piston 32 in a central position, in which the flow cross sections from the first compensator throttle 36a and the second compensator throttle 37a are preferably equally large.

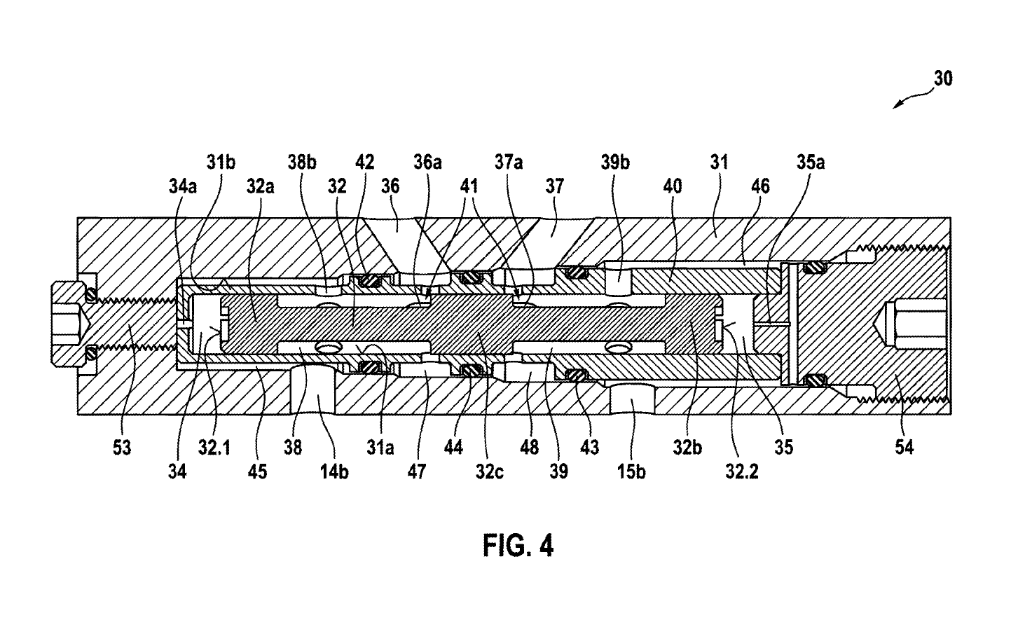

FIG. 4 shows a further exemplary embodiment of a pressure compensator 30 of a distributor valve assembly 1. The pressure compensator 30 comprises the housing 31, in which a housing bore 31b is formed in the axial direction. A substantially cylindrical control pipe 40 is disposed in the housing bore 31b. The piston bore 31a is formed in the control pipe 40, wherein the control piston 32 is disposed or respectively guided in the piston bore 31a in a longitudinally movable manner. The control piston 32 comprises the closing element 32c, which together with the piston bore 31a forms a sliding fit, a first sliding body 32a and a second sliding body 32b.

The first inlet bore 14b and the second inlet bore 15b as well as the first compensator outlet 36 and the second compensator outlet 37 are formed in the housing 31—in this embodiment all in the radial direction. The control pipe 40 and the housing 31 are provided with a plurality of bores or respectively volumes; thus enabling the first inlet bore 14b to be hydraulically connected to the first compensator outlet 36 and the second inlet bore 15b to the second compensator outlet 37.

Two pressure chambers 38, 39 are formed in the piston bore 31a of the control pipe 40: a first pressure chamber 38 is formed between the closing element 32c, the first sliding body 32a and the control pipe 40; and a second pressure chamber 39 is formed between the closing element 32c, the second sliding body 32b and the control pipe 40. In so doing, the closing element 32c hydraulically separates the first pressure chamber 38 from the second pressure chamber 39. The hydraulic separation preferably takes place in a leak-free or nearly leak-free manner.

A first connecting bore 38b and at least one second connecting bore 39b are furthermore formed in the control pipe 40. The first connecting bore 38b hydraulically connects the first inlet bore 14b to the first pressure chamber 38, and the second connecting bore 39b connects the second inlet bore 15b to the second pressure chamber 39. In so doing, respectively one or also any arbitrary number of connecting bores 38b, 39b can be configured in any desired shape.

Control slots 41 or at least one control slot 41 are furthermore formed in the control pipe 40. The at least one control slot 41 is formed in the region of the closing element 32c and in fact in such a way that the closing element 32c can cover the at least one control slot 41 such that throttles dependent on the stroke of the control piston 32 are formed there: the first compensator throttle 36a in the first hydraulic connection to the first compensator outlet 36 and the second compensator throttle 37a in the second hydraulic connection to the second compensator outlet 37.

For this purpose, the control slots 41 can be designed in various ways: for example by the opening of the control slot 41 being longer than the closing element 32c, as is depicted in the exemplary embodiment of FIG. 4; or, for example, by a plurality of control slots 41 or respectively control bores being arranged axially offset, wherein a first group of control bores then lies at least primarily in the first hydraulic connection and a second group of control bores lies at least primarily in the second hydraulic connection.

Three sealing rings 42, 43, 44 are arranged in the housing bore 31b between the housing 31 and the control pipe 40 so that the housing bore 31b between housing 31 and control pipe 40 is divided into a plurality of hydraulic chambers. A first sealing ring 42 delimits a first hydraulic chamber 45, wherein the first hydraulic chamber 45 is connected to the first inlet bore 14b. A second sealing ring 43 delimits a second hydraulic chamber 46, wherein the second hydraulic chamber 46 is connected to the second inlet bore 15b.

A third sealing ring 44, as seen in the axial direction, is disposed between the first sealing ring 42 and the second sealing ring 43 and is furthermore preferably arranged to radially surround the control slots 41 so that a short circuit cannot occur between the first compensator outlet 36 and the second compensator outlet 37. As a result, a third hydraulic chamber 47 is formed between the first sealing ring 42 and the third sealing ring 44 in the housing bore 31b. The third hydraulic chamber 47 is connected to the first compensator outlet 36 and can furthermore be connected to the first pressure chamber 38 if the closing element 32c exposes the first compensator throttle 36a. A fourth hydraulic chamber 48 is formed between the second sealing ring 43 and the third sealing ring 44 in the housing bore 31b. The fourth hydraulic chamber 48 is connected to the compensator outlet 37 and can furthermore be connected to the second pressure chamber 39 if the closing element 32c exposes the second compensator throttle 37a.

In the exemplary embodiment of FIG. 4, the control pipe 40 is fixed within the housing 31 between a screw plug 53 and an opposing mounting bolt 54, wherein both screw plug and mounting bolt 53, 54 are bolted to the housing 31 in a media-impermeable manner and interact in each case with an end face of the control pipe 40. Alternatively, only one fastener can also, for example, be used. In the example of FIG. 4, the screw plug 53 could thus be eliminated and instead a continuous housing 31 could be used.

Furthermore, the first control chamber 34 and the second control chamber 35 are each formed at an end face of the control piston 32 in the exemplary embodiment of FIG. 4. The first control chamber 34 is formed in the piston bore 31a between the first sliding body 32a or respectively the first lateral surface 32.1 and the control pipe 40 and is connected to the first hydraulic chamber 45 via a first connecting channel 34a formed in the control pipe 40. The second control chamber 35 is formed in the piston bore 31a between the second sliding body 32b or respectively the second lateral surface 32.2, the control pipe 40 and the mounting bolt 54 at the opposite end of the control piston 32 and is connected to the second hydraulic chamber 46 via a second connecting channel 35a formed in the mounting bolt 54. The second connecting channel 35a can also alternatively be formed in the control pipe 40, for example in the radial direction.

The first connecting channel 34a as well as the second connecting channel 35a can be designed as hydraulic damping throttles in order to prevent an excessively strong oscillation of the control piston 32 during the operation of the pressure compensator 30.

The first control chamber 34 is then connected to the first inlet bore 14a via the first connecting channel 34a and the first hydraulic chamber 45; and the second control chamber 35 is connected to the second inlet bore 15b via the second connecting channel 35a and the second hydraulic chamber 46. Hence, the first control chamber 34 can also be connected—in dependence on the stroke of the control piston 32—to the first compensator outlet 36 via the first connecting channel 34a, the first hydraulic chamber 45, the first connecting bore 38b, the first pressure chamber 38, the first compensator throttle 36a and the third hydraulic chamber 47. The second control chamber 35 can also be connected—likewise in dependence on the stroke of the control piston 32—to the second compensator outlet 37 via the second connecting channel 35a, the second hydraulic chamber 46, the second connecting bore 39b, the second pressure chamber 39 the second compensator throttle 37a and the fourth hydraulic chamber 48.

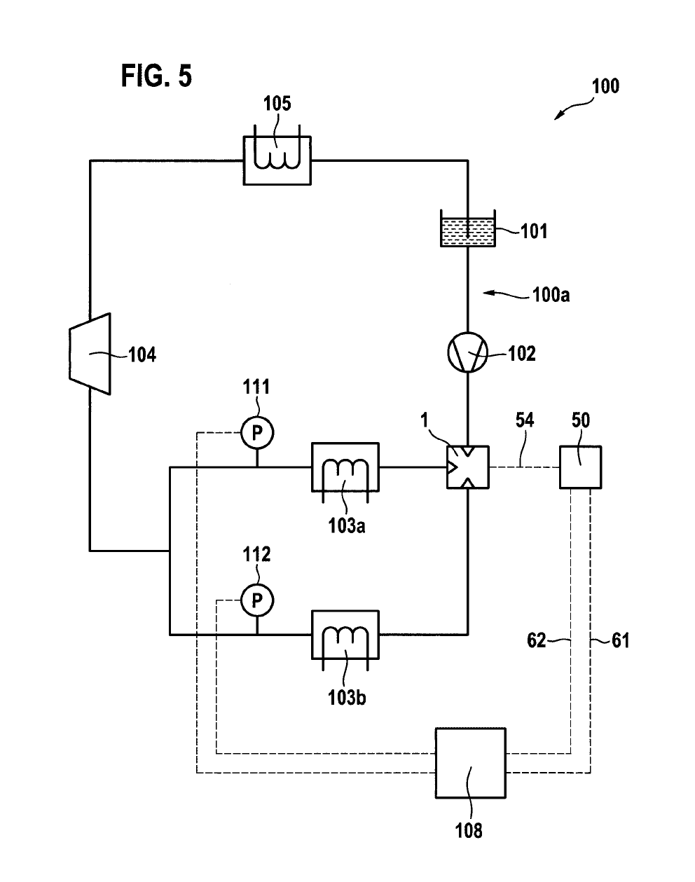

FIG. 5 shows a distributor valve assembly 1 according to the invention within a waste heat recovery system 100. The waste heat recovery system 100 has a circuit 100a that carries a working medium, said circuit comprising in the direction of flow of the working medium a reservoir 101, a pump 102, the distributor valve assembly 1, a first evaporator 103a and a second evaporator 103b in a parallel circuit, an expansion machine 104 and a condenser 105. The first evaporator 103a can, for example, be connected to an exhaust gas line of the internal combustion engine and the second evaporator 103b to an exhaust gas recirculation line of the internal combustion engine. The reservoir 101 can also alternatively be connected to the circuit 100a via a supply line. Liquid working medium is conveyed through the pump 102 out of the reservoir 101 into the evaporator 103a, 103b and is vaporized there by means of the heat energy of the exhaust gas of an internal combustion engine. The evaporated working medium is subsequently expanded in the expansion machine 104 while releasing mechanical energy, for example to a generator, which is not depicted, or to a transmission, which is not depicted. The working medium is subsequently liquefied again in the condenser 105 and is fed back into the reservoir 101 or respectively supplied to the pump 102.

The parallel circuit consisting of the two evaporators 103a, 103b can be actuated by the distributor valve assembly 1 according to the invention in an arbitrary manner. The distributor valve assembly 1 divides the mass flow of the working medium proportionally between the two evaporators 103a, 103b, wherein the first compensator outlet 36 leads to the first evaporator 103a and the second compensator outlet 37 to the second evaporator 103b.

The functionality of the distributor valve assembly 1 is as follows:

The working medium to be conveyed is supplied to the proportioning valve 10 of the distributor valve assembly 1 via the inlet channel 13. The proportioning valve 10 is actuated by a control unit such that the mass flow of the working medium is divided proportionally between the two outlet channels 14, 15 of the proportioning valve 10, for example by means of one or a plurality of closing cylinders 25, 25a, 25b. To this end, the proportioning valve 10 can be designed as an inlet or outlet controlled valve. The pressure compensator 30 is used to equalize the pressures in the two outlet channels 14, 15. As a result, the two working medium flows leaving the distributor valve unit 1, namely the mass flows through the two compensator outlets 36, 37, can be exactly determined on the basis of the stroke of the slide 24.

To this end, the pressure compensator 30 equalizes the pressures in the first control chamber 34 and in the second control chamber 35. The pressure compensator 30 compensates any pressure differences which are applied to the first compensator outlet 36 (respectively to the inlet of the first evaporator 103a) and to the second compensator outlet 37 (respectively to the inlet of the second evaporator 103b). This takes place by means of the two compensator throttles 36a, 37a. If, for example, the pressure applied to the first compensator outlet 36 is higher than that applied to the second compensator outlet 37, a larger pressure would prevail in the first control chamber than in the second control chamber 35 when the flow cross sections of the first compensator throttle 36a and the second compensator throttle 37a are the same size. Thus, the hydraulic force acting on the first lateral surface 32.1 would be larger than the hydraulic force acting on the second lateral surface 32.2. The control piston 32 is then displaced in the direction of the second control chamber 35 and thereby reduces the flow cross section of the second compensator throttle 37a. As a result, the drop in pressure in turn increases at the second compensator throttle 37a, and the pressure in the second control chamber 35 increases due to the further influent flow of the working medium via the second inlet bore 15b. The flow cross section through the second compensator throttle 37a is reduced as long as the pressures in both control chambers 34, 35 are equal. If the pressures in both control chambers are equal, the hydraulic forces acting on the two lateral surfaces 32.1, 32.2 are equal and the control piston 32 is in equilibrium in this position. The pressures in the control chambers 34, 35 are now thus equalized.

Equal pressures in the two control chambers 34, 35 is required for the robust control of the mass flows of the working medium from the inlet channel 13 to the two compensator outlets 36, 37 without thereby having to measure pressures or mass flows. With the use of the proportioning valve 10, the mass flows of the working medium into the inlet channel 13 can thus be variably and robustly divided between the two outlet channels 14, 15 and thus also between the two compensator outlets 36, 37. Because the pressures through the pressure compensator 30 are equalized in the two control chambers 34, 35, equally high pressures are also applied to the two outlet channels 14, 15 of the proportioning valve 10. That means that the mass flow of the working medium can easily be divided in accordance with the flow cross section of the two slide throttles 10a, 10b between the two outlet channels 14, 15.

The flow cross sections of the two slide throttles 10a, 10b are determined by the stroke of the slide 24. The slide 24 of the proportioning valve 10 can be actuated by the actuator 8 and be displaced. In the case of an electromagnetic actuator 8, the stroke of the slide 24 is proportional to the current passing through the actuator 8. That means, it is known at any time in which position the slide is or respectively which stroke said slide carries out. The slide 24 adjusts the cross-sectional surfaces of the two slide throttles 10a, 10b by means of the longitudinal movement thereof. The ratio of the cross-sectional surface of the first slide throttle 10a to the cross-sectional surface of the second slide throttle 10b is then simultaneously the quantity ratio between the first outlet channel 14 and the second outlet channel 15 or simultaneously the quantity ratio between the first compensator outlet 36 and the second compensator outlet 37.

If the quantity or respectively the mass flow of the working medium is therefore known, which, for example, flows via the speed-controlled pump 102 into the inlet channel 13 of the distributor valve assembly 1, the amperage at the actuator 8 can then suggest how large the respective mass flow is into the first compensator outlet 36 and into the second compensator outlet 37. The two mass flows are thus determined without a pressure or mass flow measurement. That means the two mass flows can be robustly adjusted without a direct mass flow regulation, even if different pressures prevail at the two compensator outlets 36, 37.

In advantageous embodiments, such as, for example, in the exemplary embodiment of FIG. 4, the intake into at least one of the two control chambers 34, 35 is formed by means of a damping throttle, for example by means of a throttling connecting channel 34a, 35a. As a result, the pressure oscillations in the lines (for example in the compensator outlets 36, 37 or also in the inlet channel 13) are not transmitted in an undamped manner to the control piston 32, and undesired high-frequency oscillations of the control piston 32 are prevented. Alternatively or additionally, the control piston 32 can be preloaded between the two preload springs 51, 52. In so doing, the control piston 32 is prevented from carrying out large axial movements in the control chambers 34 when small changes in pressure occur.

The embodiments of the distributor valve assembly 1 are very well suited for use within a waste heat recovery system 100 of an internal combustion engine, as is shown in FIG. 5, because a proportional division of the working medium mass flow, for example when using two parallel evaporators 103a, 103b, may be required. It is necessary for the open-loop control and closed-loop control of a corresponding waste heat recovery system 100 to be able to quantify the mass flows through the evaporators 103a, 103b. This is possible by means of the distributor valve assembly 1 according to the invention even without cost intensive mass flow or pressure sensors.

What is claimed is:

1. A distributor valve assembly (1) comprising a proportioning valve (10) and a pressure compensator (30), said proportioning valve (10) having an inlet channel (13), a first outlet channel (14) and a second outlet channel (15), wherein the proportioning valve (10) is configured to divide, between the first outlet channel (14) and the second outlet channel (15), a mass flow of a working medium flowing through the inlet channel (13), wherein the pressure compensator (30) comprises a control piston (32) that is disposed in a housing (31) in a longitudinally movable manner, wherein a first control chamber (34) and a second control chamber (35) are formed in the housing (31), wherein the control piston (32) delimits the first control chamber (34) and the second control chamber (35), wherein the first control chamber (34) is hydraulically connected to the first outlet channel (14) and the second control chamber (35) to the second outlet channel (15) on an inlet side of the pressure compensator (30), wherein the first control chamber (34) is configured to be hydraulically connected to a first compensator outlet (36) via a first compensator throttle (36a) and the second control chamber (35) to a second compensator outlet (37) via a second compensator throttle (37a) on an outlet side of the pressure compensator (30), and wherein the control piston (32) adjusts flow cross sections through the first compensator throttle (36a) and through the second compensator throttle (36b) by means of the longitudinal movement thereof.

2. The distributor valve assembly (1) according to claim 1, characterized in that the control piston (32) is preloaded between a first preload spring (51) and a second preload spring (52).

3. The distributor valve assembly (1) according to claim 1, characterized in that the first control chamber (34) is disposed between the first outlet channel (14) and the first compensator throttle (36a) and that the second control chamber (35) is disposed between the second outlet channel (15) and the second compensator throttle (37a).

4. The distributor valve assembly (1) according to claim 1, characterized in that the control piston (32) has at one end at least one first lateral surface (32.1) and has at an opposite end at least one second lateral surface (32.2), wherein the first and second lateral surfaces (32.1, 32.2) are oriented in an axial direction of the control piston (32), said at least one first lateral surface (32.1) delimiting the first control chamber (34) and said at least one second lateral surface (32.2) delimiting the second control chamber (35), wherein the at least one first lateral surface (32.1) has the same surface area as the at least one second lateral surface (32.2).

5. The distributor valve assembly (1) according to claim 1, characterized in that at least one of the first control chamber (34) and the second control chamber (35) is configured to be filled via a damping throttle (34a, 35a).

6. The distributor valve assembly (1) according to claim 1, characterized in that a control pipe (40) is disposed in the housing (31), wherein a piston bore (31a) is formed in the control pipe (40), wherein the control piston (32) is guided in a longitudinally movable manner in the piston bore (31a).

7. The distributor valve assembly (1) according to claim 6, characterized in that at least one control slot (41) is formed radially in the control pipe (40), and the control piston (32) comprises a closing element (32c), said closing element (32c) forming together with the piston bore (31a) a sliding fit and covering the at least one control slot (41) in such a way that the first compensator throttle (36a) and the second compensator throttle (36b) are formed between the closing element (32c) and the control slot (41).

8. The distributor valve assembly (1) according to claim 7, characterized in that the control piston (32) comprises a first sliding body (32a) and a second sliding body (32b), said first sliding body (32a) interacting with the piston bore (31a) and thereby delimiting the first control chamber (34) and said second sliding body (32b) interacting with the piston bore (31a) and thereby delimiting the second control chamber (35).

9. The distributor valve assembly (1) according to claim 8, characterized in that the closing element (32c) is disposed between the first sliding body (32a) and the second sliding body (32b), wherein a first pressure chamber (38) is formed in the piston bore (31a) between the first sliding body (32a) and the closing element (32c) and wherein a second pressure chamber (39) is formed in the piston bore (31a) between the second sliding body (32b) and the closing element (32c).

10. The distributor valve assembly (1) according to claim 9, characterized in that a first connecting bore (38b) and a second connecting bore (39b) are formed in the control pipe (40), the first connecting bore (38b) connecting the outlet channel (14) to the first pressure chamber (38) and the second connecting bore (39b) connecting the second outlet channel (15) to the second pressure chamber (39).

11. The distributor valve assembly (1) according to claim 9, characterized in that the first compensator throttle (36a) branches off from the first pressure chamber (38) and that the second compensator throttle (37a) branches off from the second pressure chamber (39).

12. The distributor valve assembly (1) according to claim 6, characterized in that the first control chamber (34) and the second control chamber (35) are formed in the piston bore (31a) of the control pipe (40).

13. The distributor valve assembly (1) according to claim 6, characterized in that the control pipe (40) is braced in the housing (31) by means of a mounting bolt (54).

14. The distributor valve assembly (1) according to claim 13, characterized in that the mounting bolt (54) delimits the second control chamber (35) and that the second control chamber (35) is configured to be filled via a connecting channel (35a) formed in the mounting bolt (54).

15. A waste heat recovery system (100) comprising a circuit (100a) that carries a working medium, said circuit (100a) comprising in a direction of flow of the working medium a pump (102), a distributor valve (1), two evaporators (103a, 103b) in a parallel circuit, an expansion machine (104) and a condenser (105), wherein the distributor valve assembly (1) controls mass flows of the working medium to the evaporators (103a, 103b), and wherein the distributor valve (1) is a distributor valve assembly (1) according to claim 10.
